(19) United States
(12) Patent Application Publication
(10) Pub. No.: US 2005/0112297 A1
(43) Pub. Date: May 26, 2005

(54) Optical compensation with high molecular weight polymeric addenda and process

(76) Inventors: Deepak Shukla, Webster, NY (US); James F. Elman, Fairport, NY (US); Ann L. Carroll-Lee, Webster, NY (US); David M. Teegarden, Pittsford, NY (US); Mridula Nair, Penfield, NY (US); Charles L. Bauer, Webster, NY (US); Joseph W. Hoff, Fairport, NY (US); Jason A. Payne, Rochester, NY (US)

Correspondence Address: Paul A. Leipold;Patent Legal Staff, Eastman Kodak Company, 343 State Street, Rochester, NY, 14650-2201, US

(21) Appl. No.: 10/985,612

(22) Filed: Nov. 10, 2004

Related U.S. Application Data
(63) Continuation-in-part of application No. 10/194,097, filed on Jul. 12, 2002, now abandoned.

(51) Int. Cl. C09K 19/00

(52) U.S. Cl. 428/1.1

(57) ABSTRACT

Disclosed optical compensator for a liquid crystal display and process comprising a transparent polymeric support, an orientation layer, and an optically anisotropic layer comprising a nematic liquid crystal, in order, wherein the anisotropic layer contains a colorless polymer having a weight average molecular weight that is greater that the entanglement molecular weight of the polymer. The uniformity and quality of this film is enhanced by the addition of a high molecular weight polymer.

### CROSS-REFERENCE TO RELATED APPLICATIONS

This is a Continuation-in-Part of application Ser. No. 10/194,097 filed Jul. 12, 2002. This application is cofiled as part of a group of the following commonly assigned applications under Ser. Nos. 10/194,162, 10/195,093, 10/195,094, 10/194,097, 10/194,823, 10/194,750, 10/194,130, and 10/194,100, the contents of which are incorporated herein by reference.

### FIELD OF THE INVENTION

This invention relates to an optical compensator for improving viewing angle characteristics of liquid crystal displays having a substrate, an orientation layer, and an optical anisotropic layer containing a high molecular weight polymer.

### BACKGROUND OF THE INVENTION

Current rapid expansion in the liquid crystal display (LCD) applications in various areas of information display is largely due to improvements of display qualities. Contrast, color reproduction, and stable gray scale intensities are important quality attributes for electronic displays, which employ liquid crystal technology. The primary factor limiting the contrast of a liquid crystal display is the propensity for light to “leak” through liquid crystal elements or cell, which are in the dark or “black” pixel state. Furthermore, the leakage and hence contrast of a liquid crystal display are also dependent on the angle from which the display screen is viewed. Typically the optimum contrast is observed only within a narrow viewing angle centered about the normal incidence to the display and falls off rapidly as the viewing angle is increased. In color displays, the leakage problem not only degrades the contrast but also causes color or hue shifts with an associated degradation of color reproduction. In addition to black-state light leakage, the narrow viewing angle problem in typical twisted nematic liquid crystal displays is exacerbated by a shift in the brightness-voltage curve as a function of viewing angle because of the optical anisotropy of the liquid crystal material.

Thus, one of the major factors measuring the quality of such displays is the viewing angle characteristic, which describes a change in contrast ratio from different viewing angles. It is desirable to be able to see the same image from a wide variation in viewing angles and this ability has been a shortcoming with liquid crystal display devices. One way to improve the viewing angle characteristic is to insert a compensator (also referred as compensation film, retardation film, or retarder) with proper optical properties between the polarizer and liquid crystal cell, such as disclosed in U.S. Pat. No. 5,583,679 (Ito et al.), U.S. Pat. No. 5,853,801 (Suga et al.), U.S. Pat. No. 5,619,352 (Koch et al.), U.S. Pat. No. 5,978,055 (Van De Witte et al.), and U.S. Pat. No. 6,160,597 (Schadt et al.). A compensation film according to U.S. Pat. No. 5,583,679 (Ito et al.) and U.S. Pat. No. 5,853,801 (Suga et al.), based on discotic liquid crystals which have negative birefringence, is widely used. It offers improved contrast over wider viewing angles, however, it suffers larger color shift for gray level images, compared to a compensator made of liquid crystalline materials with positive birefringence, according to Satoh et al. (“Comparison of nematic hybrid and discotic hybrid films as viewing angle compensator for NW-TN-LCDs”, SID 2000 Digest, pp. 347-349, (2000)). To achieve comparable performance in the contrast ratio while reducing color shift, one alternative is to use a pair of crossed liquid crystal polymer films (LCP) on each side of liquid crystal cell, as discussed by Chen et al. (“Wide Viewing Angle Photoaligned Plastic Films”, SID 99 Digest, pp.98-101 (1999)). This paper states that “since the second LPP/LCP retarder film is coated directly on top of the first LCP retarder film, the total thickness of the final wide-view retarder stack is only a few microns thin”. Although they provide very compact optical component, one of the challenges of this method is to make two LCP layers crossed, particularly in a continuous roll to roll manufacturing process.

U.S. Pat. No. 5,583,679 teaches that a variety of materials (polymers and surfactants) can be added to discotic liquid crystals to affect the optical performance of the resultant discotic optical compensator film by changing the tilt angle of this film. It also mentions that these materials can only be added in small amounts so as to be compatible with the discotic liquid crystal. If too much of this new material is added to the discotic then the optical compensator film will not have the desired anisotropic optical properties (optical alignment and retardation). This patent pertains only to optical compensator films made from discotic (disc shaped) liquid crystals, it does not mention nematic (rod shaped) liquid crystals. It also does not mention use of such additives to affect film uniformity.

It is a problem to be solved to provide an optical compensator that widens the viewing angle characteristics of liquid crystal displays, in particular Twisted Nematic (TN), Super Twisted Nematic (STN), Optically Compensated Bend (OCB), In Plane Switching (IPS), or Vertically Aligned (VA) liquid crystal displays (these various liquid crystal display technologies have been reviewed in U.S. Pat. No. 5,619,352 (Koch et al.), U.S. Pat. No. 5,410,422 (Bos), and U.S. Pat. No. 4,701,028 (Clerc et al.)), is readily manufactured in a roll-to-roll process. Such roll- to-roll processes require coating of an optically anisotropic layer on an orientation layer. Such layers can generally be prepared by coating solutions of polymerizable nematic liquid crystal on an orientation layer. Usually very low viscosity solutions are used in coating liquid crystals which causes many coating defects (i.e. mottle), leading to severely diminished performance of the optical compensator film and thus the complete liquid crystal display. Adding a high molecular weight polymer in coating solvents, provided they do not affect alignment and tilt angle of liquid crystals, can reduce these coating defects. While U.S. Pat. No. 5,583,679 mentions addition of such materials to discotic liquid crystals layer changes optical properties, in the present invention addition of a variety of high molecular weight polymers did not detrimentally affect the optical performance of the compensator film.

It is a problem to be solved to provide an optical compensator that widens the viewing angle characteristics of liquid crystal displays, and in particular of Twisted Nematic (TN), Super Twisted Nematic (STN), Optically Compensated Bend (OCB), In Plane Switching (IPS), or Vertically Aligned (VA) liquid crystal displays, is readily manufactured in a roll-to-roll coatable process with excellent layer uniformities and optical properties.

### SUMMARY OF THE INVENTION

The invention provides an optical compensator for a liquid crystal display comprising a transparent polymeric support, an orientation layer, and an optically anisotropic layer, in order, wherein the anisotropic layer comprises a nematic liquid crystalline polymer, and a separate colorless polymer having a weight average molecular weight that is greater that the entanglement molecular weight of the polymer. The invention also provides a process for making such a compensator.

In a desirable embodiment the separate polymer comprises from 2 to 20 wt % of the anisotropic layer and is prepared using ethylenically unsaturated monomers. In another desirable embodiment, the colorless polymer is an amorphous polymer.

The uniformity and quality of this film is enhanced by the use of a high molecular weight polymer.

### BRIEF DESCRIPTION OF THE DRAWINGS

FIG. 1 is a cross-sectional schematic view of a compensator of the present invention.

FIGS. 2A and 2B are cross-sectional schematic views of various embodiments of the present invention.

FIG. 3 is a schematic concept in accordance with the present invention.

FIG. 4 shows a liquid crystal display in combination with a compensator according to the present invention.

FIG. 5 shows a roll-to-roll process for making a compensator according to the present invention.

### DETAILED DESCRIPTION OF THE INVENTION

The current invention regarding the optical compensator for liquid crystal displays is described by referring to the drawings as follows.

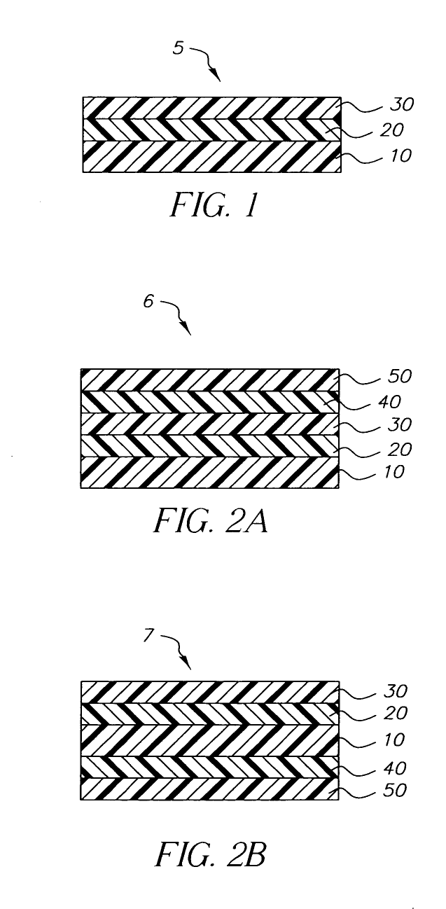

FIG. 1 shows a cross-sectional schematic view of an optical compensator 5 according to the present invention. This compensator comprises a substrate 10 of transparent material, such as glass or polymer. It should be understood that to be called as a substrate, a layer must be solid and mechanically strong so that it can stand alone and support other layers. A typical substrate is made of triacetate cellulose (TAC), polyester, polycarbonate, polysulfone, polyethersulfone, or other transparent polymers, and has a thickness of 25 to 500 micrometers. Substrate 10 typically has low in-plane retardation, preferably less than 10 nm, and more preferably less than 5 nm. In some other cases, the substrate 10 may have larger in-plane retardation between 15 to 150 nm. Typically, when the substrate 10 is made of triacetyl cellulose, it has out-of-plane retardation around −40 nm to −120 nm. This is a desired property when the compensator is designed to compensate a liquid crystal state with an ON voltage applied. The in-plane retardation discussed above is defined as the absolute value of (nx−ny)d and the out-of-plane retardation discussed above is defined as [nz−(nx+ny)/2]d, respectively. The refractive indices nx and ny are along the slow and fast axes in plane of the substrate, respectively, nz is the refractive index along the substrate thickness direction (Z-axis), and d is the substrate thickness. The substrate is preferably in the form of a continuous (rolled) film or web.

On the substrate 10, an orientation layer 20 is applied, and an anisotropic layer 30 is disposed on top of layer 20.

The orientation layer 20 can be oriented by various techniques. In one example, the orientation layer contains a rubbing-orientable material such as a polyimide or polyvinyl alcohol and can be oriented by a rubbing technique. In another example, the orientation layer contains a shear-orientable material and can be oriented by a shear-alignment technique. In another example, the orientation layer contains an electrically- or magnetically -orientable material and can be oriented by an electrical- or magnetic-alignment technique. In another example, the orientation layer can also be a layer of SiOx fabricated by oblique deposition. In another example, the orientation layer contains a photo-orientable material and can be oriented by a photo-alignment technique. Photo-orientable materials include, for example, photo isomerization polymers, photo dimerization polymers, and photo decomposition polymers. In a preferred embodiment, the photo-orientable materials are cinnamic acid derivatives as disclosed in U.S. Pat. No. 6,160,597. Such materials may be oriented and simultaneously crosslinked by selective irradiation with linear polarized UV light.

The anisotropic layer 30 is typically a nematic liquid crystalline prepolymer when it is first disposed on the orientation layer 20, and is cross-linked by a further UV irradiation, or by other means such as heat. In a preferred embodiment, the anisotropic layer contains a material such as a diacrylate or diepoxide with positive birefringence as disclosed in U.S. Pat. No. 6,160,597 (Schadt et al.) and U.S. Pat. No. 5,602,661 (Schadt et al.). The optic axis in the anisotropic layer 30 is usually tilted relative to the layer plane, and varies across the thickness direction. The anisotropic layer 30 in accordance with the present invention is applied from a liquid medium containing an organic solvent mixture and a high molecular weight polymer.

The high molecular weight polymer is chemically separate from the nematic crystalline polymer and improves the dried coating uniformity of the anisotropic layer 30 without detrimentally affecting its adhesion to orientation layer 20 or its overall optical properties.

In general these high molecular weight polymers are amorphous and colorless (no appreciable absorption between 400-800 nm) and are soluble in the coating solvent, and whose weight average molecular weight is greater than the entanglement molecular weight (i.e., a term often used to describe the molecular weight at which polymer entanglements become significant enough to contribute heavily to viscosity). More preferably their weight average molecular weight will be above 45,000. Most preferably their weight average molecular weight will be above 99,000. Furthermore, such polymers will not change the average tilt angle of the anisotropic layer 30 by more than about ±10 degrees. More preferably such polymers will not change the average tilt angle of the anisotropic layer 30 by more than about ±5 degrees. Most preferably such polymers will not change the average tilt angle of the anisotropic layer 30 by more than about ±2 degrees. In addition, such polymers will not decrease the optical retardation of the anisotropic layer 30 by more than about 50%. More preferably such polymers will not decrease the optical retardation of the anisotropic layer 30 by more than about 35%. Most preferably such polymers will not decrease optical retardation of the anisotropic layer 30 by more than about 5%.

In this case amorphous as used with respect to the polymers means that the polymer does not produce any sharp diffraction peaks when exposed to X-ray diffraction analysis. Crystalline polymers, liquid crystal molecules and crystalline inorganic materials would produce such sharp peaks when subjected to such X-ray diffraction analysis. See Chung .Frank H. and Deane K. Smith, Industrial Applications X-Ray Diffraction By comparison, Marcel Dekker, Inc; (2000) pp 495-6). Such amorphous materials are desirably suitable to be solvent cast or coated such as TAC, polycarbonates, cyclic polyolefins, polyesters, and polyimides

The high molecular weight polymer useful in the present invention include: condensation polymers such as, polyesters, polyurethanes, polyamides, and polyimides; interpolymers prepared from ethylenically unsaturated monomers such as ethylene, vinyl acetate, vinyl halide, vinylidene halide, acrylonitrile, alkyl (meth)acrylates, hydroxyalkyl (meth)acrylates, (meth)acrylic acid, methacrylonitrile, glycidyl acrylate, glycidyl methacrylate, liquid crystal acrylates, styrene and its derivatives, vinyl alkyl ethers, vinyl alkyl ketones, butadiene, vinyl silanes; and others, and mixtures thereof; derivatives of poly(vinylacetate) or poly(vinyl alcohol) such as poly(vinylbutyral), poly(vinyl formal), poly(vinylcinnamate) and others; cellulose esters; and others.

Preferred polymers for use in the present invention include: poly(vinylformal), poly(vinylacetate), poly(vinylbutyral) and poly(vinylcinnamate).

The high molecular weight polymer is added from 2% to 20 wt % of the anisotropic layer 30. More preferably such polymers are added from 2% to 10 wt % of the anisotropic layer 30. Most preferably such polymers are added from 2% to 5 wt % of the anisotropic layer 30. The amount of the high molecular weight polymer added is dependent on both the composition and molecular weight of the polymer employed since both of these can impact coating viscosity throughout the drying process.

The anisotropic layer may also contain addenda such as surfactants, light stabilizers and UV initiators. UV initiatiors include materials such as benzophenone and acetophenone and their derivatives; benzoin, benzoin ethers, benzil, benzil ketals, fluorenone, xanthanone, alpha and beta naphthyl carbonyl compounds and ketones. Preferred initiators are alpha-hydroxyketones.

While this type of compensator described above provides some desired optical properties, it is not sufficient in many applications, for example, as a compensator for Twisted Nematic (TN) Liquid Crystal Displays (LCDs).

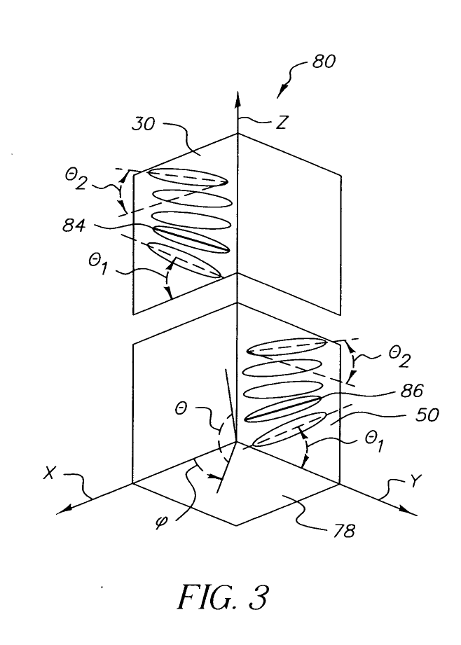

FIG. 2A illustrates a more sophisticated optical compensator 6 of the invention that contains a second orientation layer 40 and a second anisotropic layer 50 on top of the first anisotropic layer 30. The second orientation layer 40 and the second anisotropic layer 50 are made essentially in the same way as the first orientation layer 20 and the first anisotropic layer 30 are made, except that the direction of the orientation may vary. For the purpose of illustration, refer to an XYZ coordinate system 80 as shown in FIG. 3. The X and Y axes are parallel to the plane of substrate 78, and the Z-axis is perpendicular to the plane of substrate 78. The angle φ is measured from the X-axis in the XY plane, and referred as an azimuthal angle. The angle θ is measured from the XY plane, and referred as a tilt angle.

It should be understood that the optic axis in each of the anisotropic layers 30 and 50 can have a variable tilt angle and/or variable azimuthal angle. For example, the optic axis 84 in the anisotropic layer 30 has a variable tilt angle θ across the Z-axis ranging from θ₁ to θ₂. In another example, the optic axis 84 has a fixed tilt angle θ across the Z-axis, namely, θ₁=θ₂. In another example, the optic axis 84 is contained in one plane such as the XZ plane and consequently has a fixed azimuthal angle φ across the Z-axis. In another example, although the anisotropic layer 30 is still oriented along the preferred direction forced by the orientation layer at their interface, the optic axis 84 has a variable azimuthal angle φ across the Z-axis. The azimuthal angle of the optic axis 84 can be varied by adding a proper amount of chiral dopant into the anisotropic layer 30. In another example, the optic axis 84 has a variable tilt angle θ and a variable azimuthal angle φ across the Z-axis. Like the optic axis 84 of the anisotropic layer 30, the optic axis 86 of the anisotropic layer 50 can also have a fixed tilt angle, a variable tilt angle, a fixed azimuthal angle, a variable azimuthal angle, or a variable tilt angle and a variable azimuthal angle across the Z-axis. The anisotropic layers 30 and 50 typically have different optic axis. Preferably the anisotropic layer 30 is positioned orthogonally relative to the respective optic axis of the anisotropic layer 50 about an axis perpendicular to the plane of the substrate. Even though the optic axis of the anisotropic layer 30 is preferred to be orthogonal (or ±90 degrees) relative to the respective (or counterpart) optic axis of the anisotropic layer 50 about an axis perpendicular to the plane of the substrate, it should be understood that the angle between the optic axis of the two anisotropic layers can be in a range of 85 to 95 degrees to be considered as orthogonal.

For the manufacture of more complex layer structures than that illustrated in FIG. 2A, additional orientation and anisotropic layers can be applied in further steps.

FIG. 2B illustrates another optical compensator 7 of the invention in which the second orientation layer 40 and the second anisotropic layer 50 are on the opposite side of the substrate from the first orientation layer 20 and the first anisotropic layer 30.

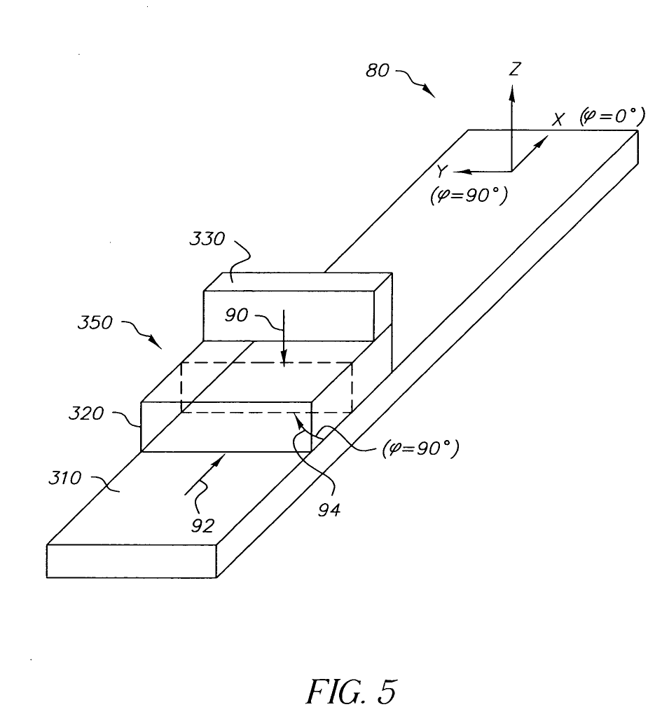

FIG. 5 shows another aspect of the present invention. A compensator 350 can be manufactured on a continuous roll-to-roll basis as shown in FIG. 5 which shows part of a schematic view of the process. The roll-to-roll process of forming a compensator 350 comprises the steps of applying a photo-alignable orientation layer 320, for example by coating by any known method such as extrusion hopper coating, roll-coating, slide hopper coating, or curtain coating, the orientable material in a solvent, onto a moving substrate 310, drying the orientation layer 320, photo-aligning (orienting) the orientation layer 320 in a predetermined alignment direction φ 94, (for the purpose of illustration φ=90°) relative to the roll moving direction 92, coating (as described earlier)an anisotropic layer 330 comprising a polymerizable material in a solvent carrier onto the orientation layer 320, drying the anisotropic layer 330, polymerizing the anisotropic layer 330 to form a continuous web of compensator. Note that for clarity, FIG. 5 only shows part of the orientation layer 320 and anisotropic layer 330.

In one embodiment, the orientation layer is oriented by rubbing the orientation layer in a direction 94 of 90 degrees (φ=90°) relative to the roll moving direction 92. In another embodiment, the orientation layer is oriented by a photo-alignment technique, for example, the orientation layer is exposed to a linearly polarized ultraviolet (UV) light indicated by 90. It may or may not be collimated, however, the projection (pointing along 94) of the principal ray of the light 90 onto the roll makes an angle of about 90 degrees relative to the roll moving direction.

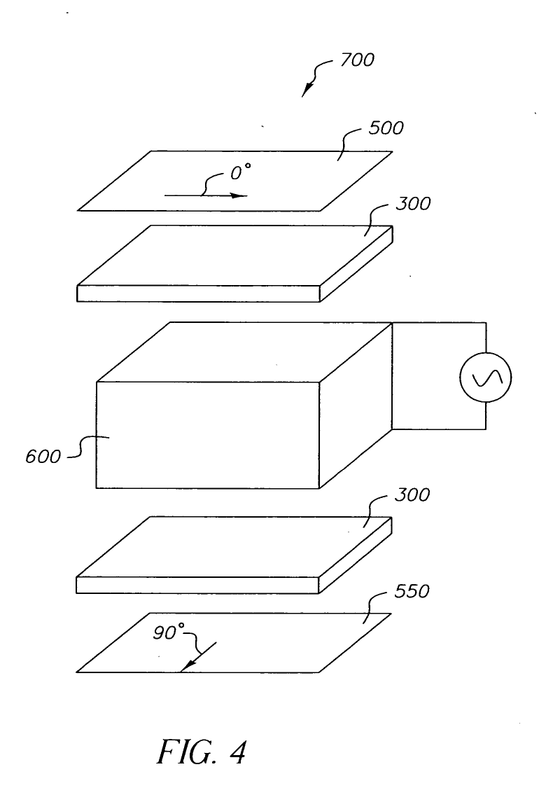

FIG. 4 is a schematic view of a liquid crystal display 700 comprising the compensator 300 in accordance with the present invention. In FIG. 4B, one compensator 300 is placed between the first polarizer 500 and the liquid crystal cell 600, and another compensator 300 is placed between a second polarizer 550 and the liquid crystal cell 600. The liquid crystal cell 600 is preferred to be operated in a Twisted Nematic (TN), Super Twisted Nematic (STN), Optically Compensated Bend (OCB), In Plane Switching (IPS), or Vertically Aligned (VA) mode. The polarizers 550 and 500 can be arranged crossed or parallel depending on the operation principles of the liquid crystal cell. The orientation layer in the compensator can be arranged parallel, perpendicular, or at a predetermined angle relative to the first polarizer 500. The liquid crystal cell can also be operated in a reflective mode, in which it may only require one polarizer.

The invention may be used in conjunction with electronic imaging device comprising a liquid crystal display device. The energy required to achieve this control is generally much less than that required for the luminescent materials used in other display types such as cathode ray tubes. Accordingly, liquid crystal technology is used for a number of applications, including but not limited to digital watches, calculators, portable computers, electronic games for which light weight, low power consumption and long operating life are important features.

The present invention is illustrated in more detail by the following non-limiting examples.

### COMPARISON EXAMPLE A

Coating of Photo-Aligned Anisotropic Layer for Layer Uniformity.

Onto a photo-aligned orientation layer prepared from a mixture of VANTICO Staralign 2110 and Staralign 2100 photo-aligning vinyl cinnamate polymers on cellulose triacetate support, a methyl ethyl ketone solution of crosslinkable diacrylate nematic liquid crystalline compound (7 wt %) (obtained by diluting 30 wt % stock solution of VANTICO LCP 483) was slot hopper cast. The sample was then heated to 55° C. to orient the nematic liquid crystalline layer and remove solvent. The sample was cooled to room temperature and anisotropic layer fixed by exposing to 365 nm light (300-1000 mJ/cm²) under an atmosphere of nitrogen. The sample was the viewed between crossed polarizers and judged for appearance.

### EXAMPLE 1

Coating of Photo-Aligned Anisotropic Layer Containing a High Molecular Weight Polymer to Improve Layer Uniformity.

Onto a photo-aligned orientation layer prepared from a mixture of VANTICO Staralign 2110 and Staralign 2100 photo-aligning vinyl cinnamate polymers on cellulose triacetate support, a methyl ethyl ketone solution of crosslinkable diacrylate nematic liquid crystalline compound (7 wt %) (obtained by diluting 30 wt % stock solution of VANTICO LCP 483) and poly(vinylacetate) having a weight average molecular weight of 185,000 (2.4 wt % of dried anisotropic film) was slot hopper cast. The sample was then heated to 55° C. to orient the nematic liquid crystalline layer and remove solvent. The sample was cooled to room temperature and anisotropic layer fixed by exposing to 365 nm light (300-1000 mJ/cm²) under an atmosphere of nitrogen.

Comparison Example A and Example 1 were then viewed between crossed polarizing filters to determine the effect of the high molecular weight polymer on the resulting dried anisotropic layer uniformity, and a visual rating was assigned. The rating considered all obvious post-application imperfections, including mottle, drying convection cells, and repellencies. A rating of 1 corresponds to the poorest possible quality and a rating of 10 the best possible quality.

TABLE 1

| | Layer Uniformity as Observed |
|---|---|
| Sample | Between Crossed Polarizers |
| Comparison | 2 |
| Example A | |
| Example 1 | 8 |

### COMPARISON EXAMPLE B

Preparation of Photo-Aligned Anisotropic Layer.

On a clean glass plate, a coating solution containing a mixture of VANTICO Staralign 2110 and Staralign 2100 photo-aligning vinyl cinnamate polymers (1 wt % total solids in MEK) was spun cast (@ 1000 rpm). Sample was dried at 55° C. for 5 min. and then exposed to 308 nm polarized light (15-30 mJ/cm²) at an inclination of 20 degrees away from normal angle of incidence to obtain a photo-aligned orientation layer. Typically this will produce a layer thickness between 30-100 nm as measured by ellipsometry (J. A. Woollam Co., Model M2000V). On the orientation layer a methyl ethyl ketone solution of crosslinkable diacrylate nematic liquid crystalline compound (7 wt %) (obtained by diluting 30 wt % stock solution of VANTICO LCP 483) was spun cast (@ 1000 rpm). The sample was then heated at a temperature of 55° C. for 3 minutes to orient the nematic liquid crystalline layer and remove solvent. The sample was cooled to room temperature and anisotropic layer fixed by exposing to 365 nm light (300-1000 mJ/cm²) under an atmosphere of nitrogen. In-plane retardation, average tilt angle, and thickness of the anisotropic layer were measured by ellipsometry (J. A. Woollam Co., Model M2000V). The measured average tilt angle method had errors of ±2.0 degrees.

### EXAMPLE 2

Preparation of Photo-Aligned Anisotropic Layer with Added Poly(Vinylacetate)

On a clean glass plate, a coating solution containing a mixture of VANTICO Staralign 2110 and Staralign 2100 photo-aligning polymers (1 wt % solids in MEK) was spun cast (@ 1000 rpm). Sample was dried at 55° C. for 5 min. and then exposed to 308 nm polarized light (15-30 mJ/cm²) at an inclination of 20 degrees away from normal angle of incidence to obtain a photo-aligned orientation layer. Typically this will produce a layer thickness between 30-100 nm as measured by ellipsometry (J. A. Woollam Co., Model M2000V).

On the orientation layer a methyl ethyl ketone solution of crosslinkable diacrylate nematic liquid crystalline compound (7 wt %) (obtained by diluting 30 wt % stock solution of VANTICO LCP 483) and a high molecular weight polymer (at a wt % of dried anisotropic film as indicated in Table 2) was spun cast (@ 1000 rpm). The sample was then heated at a temperature of 55° C. for 3 minutes to orient the nematic liquid crystalline layer and remove solvent. The sample was cooled to room temperature and anisotropic layer fixed by exposing to 365 nm light (300-1000 mJ/cm²) under an atmosphere of nitrogen. In-plane retardation, average tilt angle, and thickness of the anisotropic layer were measured by ellipsometry (J. A. Woollam Co., Model M2000V). The measured average tilt angles had errors of ±2.0 degrees.

TABLE 2

| | Polymer | Layer | In Plane | Average |
|---|---|---|---|---|
| | Weight | Thick- | Retardation | Tilt |
| Sample (wt % in dried | Ave | ness, | nm(measured | Angle |
| film) | Mol. Wt. | (nm) | @ 550 nm) | (±2) |
| Comparison Ex. B | No polymer | 525 | 43 | 26 |
| | added | | | |
| poly(vinylacetate) | 185,000 | 500 | 43 | 23 |
| (2.4 wt %) | | | | |
| poly(vinylcinnamate) | 88,000 | 540 | 41 | 24 |
| (2.4 wt %) | | | | |
| poly(vinylphenyl | 128,000 | 581 | 36 | 26 |
| acetate) (13 wt %) | | | | |
| Butvar 76 | 90,000- | 736 | 57 | 25 |
| (1 wt %) | 120,000 | | | |

The aforementioned examples clearly demonstrate that compared to comparison example B addition of a high molecular weight polymer does not change optical properties of anisotropic layer.

The entire contents of the patents and other publications referred to in this specification are incorporated herein by reference.

### Parts list

5 compensator according to the present invention
6 compensator according to the present invention
7 compensator according to the~present invention
10 substrate
20 orientation layer
30 anisotropic layer
40 orientation layer
50 anisotropic layer
78 plane of substrate (or XY plane)
80 XYZ coordinate system
84 optic axis in the anisotropic layer 30
86 optic axis in the anisotropic layer 50
90 UV light
92 roll moving direction
94 alignment direction
300 compensator according to the present invention
310 moving substrate
320 orientation layer
330 anisotropic layer
350 compensator according to the present invention
500 polarizer
550 polarizer
600 liquid crystal cell
700 liquid crystal display
θ tilt angle
φ azimuthal angle

1. An optical compensator for a liquid crystal display comprising a transparent polymeric support, an orientation layer, and an optically anisotropic layer comprising a nematic liquid crystal, in order, wherein the nematic liquid crystal is crosslinked and wherein the anisotropic layer additionally contains a separate colorless polymer having a weight average molecular weight that is greater that the entanglement molecular weight of the polymer and wherein the polymer comprises from 2 to 20 wt % of the anisotropic layer and is prepared using ethylenically unsaturated monomers.

2. The compensator of claim 1 wherein the molecular weight of the colorless polymer is above 45,000.

3. The compensator of claim 1 wherein the molecular weight of the colorless polymer is above 99,000.

4. The compensator of claim 1 wherein the type and amount of colorless polymer is not sufficient to alter the tilt angle of the anisotropic layer by more than ±10° compared to the same layer without the polymer.

5. The compensator of claim 4 wherein the type and amount of colorless polymer is not sufficient to alter the tilt angle of the anisotropic layer by more than ±5° compared to the same layer without the polymer.

6. The compensator of claim 4 wherein the type and amount of colorless polymer is not sufficient to alter the tilt angle of the anisotropic layer by more than ±2° compared to the same layer without the polymer.

7. The compensator of claim 1 wherein the type and amount of colorless polymer is not sufficient to alter the retardation of the anisotropic layer by more than 50%° compared to the same layer without the polymer.

8. The compensator of claim 1 wherein the type and amount of colorless polymer is not sufficient to alter the retardation of the anisotropic layer by more than 35%° compared to the same layer without the polymer.

9. The compensator of claim 1 wherein the type and amount of colorless polymer is not sufficient to alter the retardation of the anisotropic layer by more than 5%° compared to the same layer without the polymer.

10. The compensator of claim 1 wherein the colorless polymer is amorphous.

11. The compensator of claim 1 wherein the colorless polymer includes a copolymer.

12. The compensator of claim 1 wherein the ethylenically unsaturated monomers are selected from the group consisting of ethylene, vinyl acetate, vinyl halide, vinylidene halide, acrylonitrile, alkyl (meth)acrylates, hydroxyalkyl (meth)acrylates, (meth)acrylic acid, methacrylonitrile, glycidyl acrylate, glycidyl methacrylate, styrene, vinyl alkyl ethers, vinyl alkyl ketones, butadiene, vinyl silanes; and mixtures, copolymers and derivatives thereof.

13. The compensator of claim 1 wherein the polymer comprises a poly(vinylacetate), poly(vinylphenylacetate) or poly(vinyl alcohol).

14. The compensator of claim 1 wherein the polymer comprises a poly(vinylbutyral), poly(vinyl formal), or poly(vinylcinnamate).

15. The compensator of claim 1 wherein the polymer comprises a cellulosic polymer.

16. The compensator of claim 1 wherein the polymer comprises up to 10 wt % of the anisotropic layer.

17. The compensator of claim 1 wherein the polymer comprises from 2 to 10 wt % of the anisotropic layer.

18. The compensator of claim 1 wherein the polymer comprises from 2 to 5 wt % of the anisotropic layer.

19. The compensator of claim 1 wherein the orientation layer is capable of orientation through photoalignment using polarized light.

20. The compensator of claim 1 wherein the orientation layer comprises a polyvinyl cinnamate.

21. The compensator of claim 1 wherein the nematic liquid crystal is a UV crosslinked material.

22. A liquid crystal display comprising a compensator of claim 1.

23. A process for preparing a compensator for a liquid crystal display comprising providing a transparent support, coating an orientation layer from an organic solvent over the support and then drying and aligning the orientation layer, and then coating and polymerizing over the orientation layer an anisotropic liquid crystal layer comprising a polymerizable material in a solvent carrier wherein the anisotropic layer also contains a colorless polymer having a weight average molecular weight that is above 45,000 wherein the polymer comprises from 2 to 20 wt % of the anisotropic layer and is prepared using ethylenically unsaturated monomers.

24. The process of claim 23 wherein the colorless polymer has a weight average molecular weight that is above 99,000.

25. A process for making an optical compensator, comprising the steps of:
a) coating an orientation layer comprising a photo-alignable polymer in a solvent over a transparent support;
b) drying the orientation layer;
c) photo-aligning the orientation layer in a predetermined direction;
d) coating over the orientation layer an anisotropic liquid crystal layer comprising a polymerizable material in a solvent carrier wherein the anisotropic layer also contains an amorphous colorless polymer having a weight average molecular weight that is above 45,000;
e) drying the anisotropic layer;
f) polymerizing the anisotropic layer
g) repeating steps a) through f) coating over the polymerized anisotoropic layer of f) but photo-aligning the orientation layer at a predetermined angle to the direction in step c).

26. The process of claim 25 wherein the predetermined angle of step g) to the direction in step c) is 90°.

27. A continuous process for making an optical compensator on a support web, comprising the steps of:
a) coating an orientation layer comprising a photo-alignable polymer in an organic solvent over the support;
b) drying the orientation layer;
c) photoaligning the orientation layer in a predetermined direction relative to the web moving direction;
d) coating over the orientation layer an anisotropic layer comprising a polymerizable material and a colorless amorphous polymer having a weight average molecular weight that is above 45,000 in a solvent carrier;
e) drying the anisotropic layer;
f) polymerizing the anisotropic layer to form a first continuous web of a multilayer integral component;
g) repeating the above steps a) through f) coating over the anisotropic layer obtained from e) but photo-aligning the orientation layer at a predetermined angle to the direction in step c).

28. The process of claim 27 wherein the predetermined angle of step i) to the direction in step c) is 90°.

29. A process for preparing a compensator for a liquid crystal display comprising providing a transparent support, coating an orientation layer from an organic solvent over the support and then drying and aligning the orientation layer, and then coating and polymerizing over the orientation layer an anisotropic liquid crystal layer comprising a polymerizable material in a solvent carrier wherein the anisotropic layer also contains a colorless amorphous polymer having a weight average molecular weight that is greater than the entanglement molecular weight of the polymer.

30. The process of claim 29 wherein the colorless polymer has a weight average molecular weight that is above 45,000.

31. The process of claim 29 wherein the colorless polymer has a weight average molecular weight that is above 99,000.

32. A process for making an optical compensator, comprising the steps of:
a) coating an orientation layer comprising a photo-alignable polymer in a solvent over a transparent support;
b) drying the orientation layer;
c) photo-aligning the orientation layer in a predetermined direction;
d) coating over the orientation layer an anisotropic liquid crystal layer comprising a polymerizable material in a solvent carrier wherein the anisotropic layer also contains a colorless amorphous polymer having a weight average molecular weight that is greater than the entanglement molecular weight of the polymer;
e) drying the anisotropic layer;
f) polymerizing the anisotropic layer g) repeating steps a) through f) coating over the polymerized anisotoropic layer of f) but photo-aligning the orientation layer at a predetermined angle to the direction in step c).

33. The process of claim 25 wherein the predetermined angle of step g) to the direction in step c) is 90°.

34. A continuous process for making an optical compensator on a support web, comprising the steps of:
a) coating an orientation layer comprising a photo-alignable polymer in an organic solvent over the support;
b) drying the orientation layer;
c) photoaligning the orientation layer in a predetermined direction relative to the web moving direction;
d) coating over the orientation layer an anisotropic layer comprising a polymerizable material and a colorless polymer, having a weight average molecular weight that is greater than the entanglement molecular weight of the polymer, in a solvent carrier;
e) drying the anisotropic layer;
f) polymerizing the anisotropic layer to form a first continuous web of a multilayer integral component;
g) repeating the above steps a) through f) coating over the anisotropic layer obtained from e) but photo-aligning the orientation layer at a predetermined angle to the direction in step c).

35. The process of claim 34 wherein the predetermined angle of step g) to the direction in step c) is 90°

36. An optical compensator for a liquid crystal display comprising a transparent polymeric support, an orientation layer, and an optically anisotropic layer and an optically anisotropic layer, in order, wherein the anisotropic layer comprises (1) a nematic liquid crystalline polymer, and (2) a separate colorless amorphous polymer having a weight average molecular weight that is greater that the entanglement molecular weight of the polymer.

37. The compensator of claim 36 wherein the molecular weight of the colorless polymer is above 99,000.

38. The compensator of claim 36 wherein the type and amount of colorless polymer is not sufficient to alter the tilt angle of the anisotropic layer by more than ±10° compared to the same layer without the polymer.

39. The compensator of claim 38 wherein the type and amount of colorless polymer is not sufficient to alter the tilt angle of the anisotropic layer by more than ±5° compared to the same layer without the polymer.

40. The compensator of claim 38 wherein the type and amount of colorless polymer is not sufficient to alter the tilt angle of the anisotropic layer by more than ±2° compared to the same layer without the polymer.

41. The compensator of claim 36 wherein the type and amount of colorless polymer is not sufficient to alter the retardation of the anisotropic layer by more than 35%° compared to the same layer without the polymer.

42. The compensator of claim 36 wherein the type and amount of colorless polymer is not sufficient to alter the retardation of the anisotropic layer by more than 5%° compared to the same layer without the polymer.

43. The compensator of claim 36 wherein the polymer comprises from 2 to 10 wt % of the anisotropic layer.

44. The compensator of claim 36 wherein the polymer comprises from 2 to 5 wt % of the anisotropic layer.

45. The compensator of claim 36 wherein the orientation layer is capable of orientation through photoalignment using polarized light.

46. The compensator of claim 36 wherein the orientation layer comprises a polyvinyl cinnamate.

47. The compensator of claim 36 wherein the nematic liquid crystal is a UV crosslinked material.

48. A liquid crystal display comprising a compensator of claim 36.
